(19) United States
(12) Patent Application Publication
(10) Pub. No.: US 2006/0000925 A1
(43) Pub. Date: Jan. 5, 2006

(54) Reduced sized micro-fluid jet nozzle structure

(76) Inventors: Colin G. Maher, Georgetown, KY (US); Sam Norasak, Lexington, KY (US); James H. Powers, Lexington, KY (US); David C. Weatherly, Versailles, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/881,652

(22) Filed: Jun. 30, 2004

(51) Int. Cl. B05B 1/08; A62C 31/02

(52) U.S. Cl. 239/102.1; 239/589

(57) ABSTRACT

A nozzle plate structure having nozzle bores therein in flow communication with corresponding fluid chambers. The nozzle bores have an overall nozzle bore length dimension and each of the nozzle bores includes two or more exit bores in fluid flow communication with each of the nozzle bores. Each of the exit bores having a length dimension ranging from about 5 to about 100 percent of the overall nozzle bore length dimension.

### FIELD OF THE DISCLOSURE

The disclosure relates to improved nozzle holes for micro-fluid ejection devices and to methods for making the nozzle holes.

### BACKGROUND

Fluid ejection droplet size from a micro-fluid ejection device is an important parameter for achieving desired results. For example, the quality of images printed by an ink jet printer onto a medium is greatly influenced by the size of the ink droplets ejected by the printhead. Currently, eleven micron diameter nozzles produce a two to five nanogram droplet size. As smaller droplets are desired, the nozzle diameter is decreased along with an ejection actuator size decrease. However, as the nozzle diameter decreases, problems arise in the manufacture and operation of such nozzles. Smaller nozzles are more prone to blockage from contamination. Also, in the case of printing, more droplets are required to be delivered for an image, thereby slowing down the printing process.

Attempts have been made to provide multiple smaller nozzle holes for a single fluid chamber. However, these attempts often provide nozzle bores through the nozzle plate material with too high an aspect ratio for efficient fluid ejection.

Hence, there continues to be a need for improved nozzle plates for micro-fluid ejection devices.

### SUMMARY

With regard to the foregoing and other objects and advantages there is provided a nozzle plate structure having nozzle bores therein in flow communication with corresponding fluid chambers. The nozzle bores have an overall nozzle bore length dimension and each nozzle bore includes two or more exit bores in fluid flow communication with each nozzle bore. Each of the exit bores having a length dimension ranging from about 5 to about 100 percent of the overall nozzle bore length dimension.

In another embodiment there is provided a method of making a nozzle plate for a micro-fluid ejection head. The method includes partially laser ablating a single nozzle bore for each fluid chamber in a nozzle plate material. Multiple exit bores corresponding to each nozzle bore are laser ablated in the nozzle plate material. The exit bores have a length dimension ranging from about 5 to about 100 percent of an overall nozzle bore length dimension.

Another embodiment provides a method of reducing fluid droplet size without substantially reducing fluid droplet volume from a micro-fluid ejection head. The method includes partially laser ablating a single nozzle bore for each fluid chamber in a nozzle plate material. Multiple exit bores corresponding to each nozzle bore in the nozzle plate material are also laser ablated in the nozzle plate material. The exit bores have a length dimension ranging from about 5 to about 100 percent of an overall nozzle bore length dimension. The nozzle plate material containing the laser ablated nozzle bores and exit bores is attached to a semiconductor substrate containing fluid ejection actuators. Fluid is ejected from the exit bores of the nozzle plate material by activating the fluid ejection actuators to provide multiple droplets from the exit bores for each nozzle bore having a total volume ranging from about one to about eight nanograms.

An advantage of the embodiments described herein can be the ability to provide multiple small fluid droplets during a single fluid ejection actuation step without significantly reducing the total volume of fluid ejected during the actuation step. Such an ability is particularly suitable for ink jet printing operations wherein smaller droplets provide a smoother more desirable image. In the present embodiments, even though smaller droplets are ejected from each corresponding nozzle bore, the volume of fluid remains substantially the same as the volume for a single larger droplet. Accordingly, there is little or no reduction in print speed associated with the production of smaller droplets.

The disclosed embodiments also provide a means for ejecting small droplets from a single fluid chamber without significantly affecting the jetting efficiency for the droplets. Unlike other ejection heads having multiple nozzle holes for a single fluid chamber, the multiple exit bores provided in the nozzle plate according to the disclosed embodiments have relatively small aspect ratios thereby reducing fluid resistance.

### BRIEF DESCRIPTION OF THE DRAWINGS

Further advantages of the disclosed embodiments will become apparent by reference to the detailed description of exemplary embodiments when considered in conjunction with the following drawings illustrating one or more non-limiting aspects of the embodiments, wherein like reference characters designate like or similar elements throughout the several drawings as follows:

FIG. 1 is a plan view, not to scale, of a nozzle hole in a nozzle plate according to the prior art;

FIG. 2 is a cross-sectional view, not to scale, of a portion of a prior art micro-fluid ejection head;

FIG. 3 is a plan view, not to scale, of a nozzle hole in a nozzle plate according an embodiment of the disclosure;

FIG. 4 is a cross-sectional view, not to scale, of a portion of a nozzle plate during a manufacturing process therefor according to the disclosure;

FIG. 5 is a plan view, not to scale, of a completed nozzle hole in the nozzle plate of FIG. 4;

FIG. 6 is a cross-sectional view, not to scale, of a portion of a micro-fluid ejection device containing the completed nozzle plate of FIG. 5;

FIG. 7 is a cross-sectional view, not to scale, of a portion of a micro-fluid ejection device containing an alternative nozzle plate of FIG. 5;

FIG. 8 is a plan view, not to scale, of a mask for the nozzle plate of FIG. 5;

FIG. 9 is a plan view, not to scale, of exit bores in a nozzle plate according to another embodiment of the disclosure;

FIG. 10 is a cross-sectional view, not to scale, of a portion of a micro-fluid ejection device containing the nozzle plate of FIG. 9;

FIG. 11 is a cross-sectional view, not to scale, of a portion of a micro-fluid ejection device containing an alternative nozzle plate of FIG. 9; and

FIG. 12 is a plan view, not to scale, of a nozzle plate according to another embodiment of the disclosure.

### DETAILED DESCRIPTION OF THE EMBODIMENTS

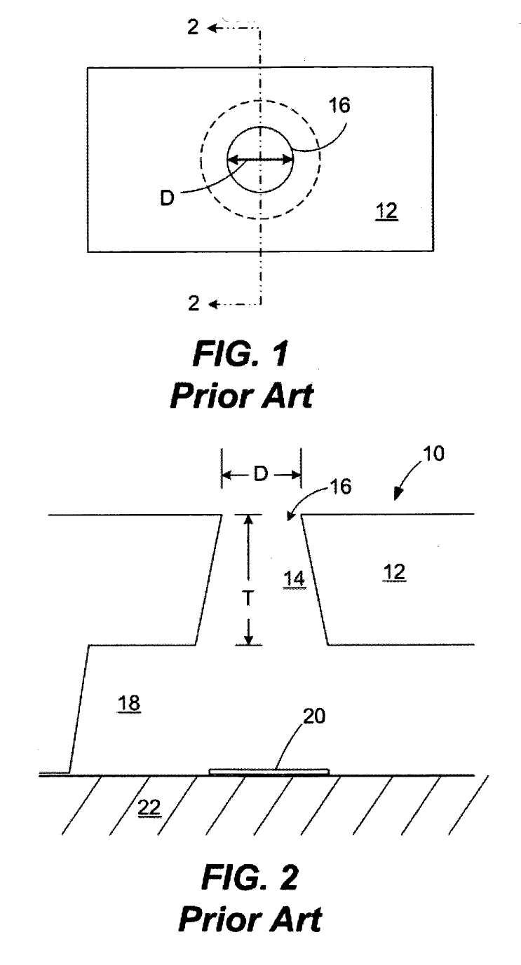

With reference to FIGS. 1 and 2, a portion of a prior art micro-fluid ejection head 10 is illustrated. The micro-fluid ejection head 10 includes a nozzle plate 12 containing a nozzle bore 14, providing nozzle hole 16. The nozzle plate 12 is typically made of a corrosion resistant polymer, such as polyimide. The nozzle bore 14 is in fluid flow communication with a fluid chamber 18 provided by ablating a portion of the nozzle plate 12 or by providing a separate thick film layer (not shown). A fluid ejection actuator 20 for each of the nozzle holes 16 is provided on a semiconductor substrate 22. As shown in FIG. 2, the nozzle bore 14 is a substantially continuous bore through a thickness T of the nozzle plate 12. The overall length of the nozzle bore 14 depends on the thickness of the nozzle plate and may range from about 16 to about 65 microns. As the exit diameter D of the nozzle hole 16 is decreased to decrease the amount of fluid ejected, an aspect ratio T/D becomes larger thereby reducing an efficiency of ejection of fluid from the nozzle hole 16. For fluids such as inks, the volume of fluid ejected from nozzle hole 16 typically ranges from about one to about eight nanograms for high quality printing applications.

As the exit diameter D of the nozzle hole 16 decreases, an ink delivery rate from the nozzle hole 16 also decreases. For example, printing applications wherein ink is ejected from the micro-fluid ejection device 10, require more time to provide the same volume of ink printed thereby slowing down the printing speed.

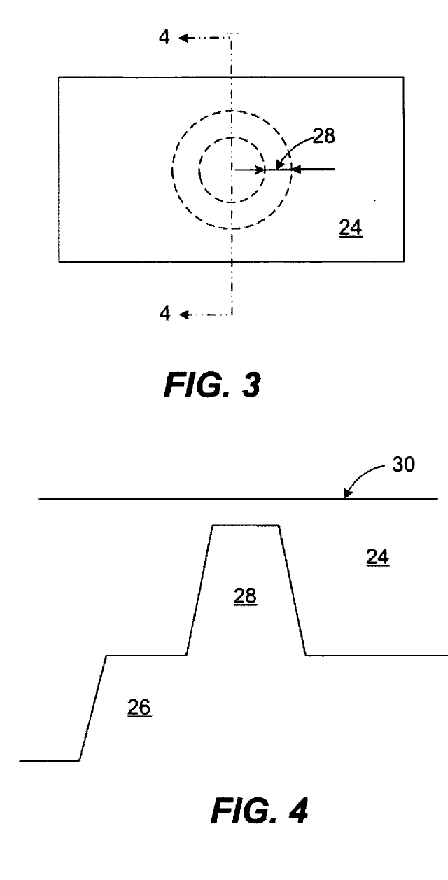

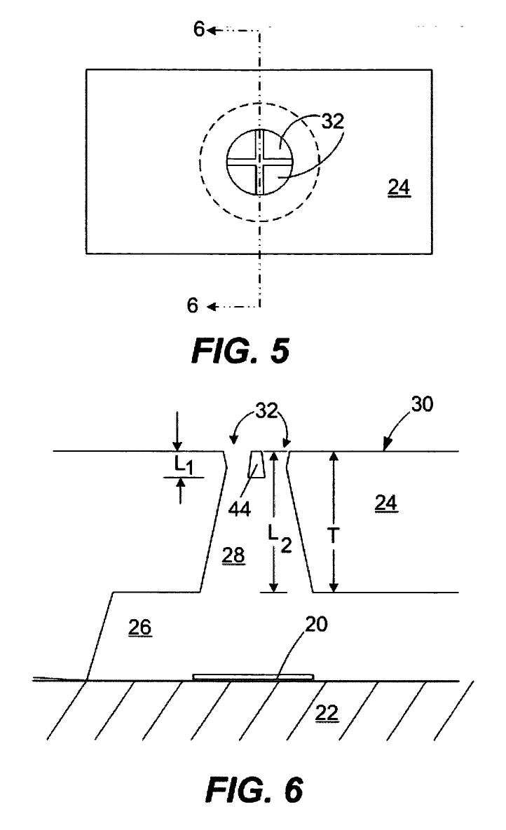

In order to decrease a droplet size ejected from a micro-fluid ejection device without substantially decreasing the total drop volume during one ejection sequence, a two step laser ablation process for forming a nozzle bore and exit bore is illustrated in FIGS. 3-8. In FIGS. 3 and 4, a nozzle plate 24 according to one embodiment of the disclosure is illustrated. The nozzle plate 24 is ablated to provide a fluid chamber 26 and a nozzle bore 28 that extends part way through the nozzle plate 24 from the ink chamber 26 to an exit surface 30 of the nozzle plate 24.

In a next step of the process, two or more exit bores 32 are laser ablated in the nozzle plate 24. The exit bores 32 have a length dimension L₁, referred to herein as the “exit bore length” ranging from about 5 to about 100 percent of the overall nozzle bore 28 length L₂, which, as set forth above, may range from about 15 to about 65 microns. The exit bores 32 are ablated from the exit surface 30 of the nozzle plate 24 whereas the nozzle bore 28 is ablated from the fluid chamber 26 side of the nozzle plate 24. Laser ablation of the nozzle bore 28 and exit bores 32 may be conducted using a single laser and flipping the nozzle plate 24 over once the fluid chamber 26 and nozzle bore 28 are ablated in the nozzle plate 24 to complete the formation of the exit bores 32. Such a nozzle plate may also be provided by using two lasers, one to ablate nozzle bore 28 and one to ablate exit bores 32. A single laser having a split laser beam may also be used to ablate nozzle bore 28 and exit bores 32.

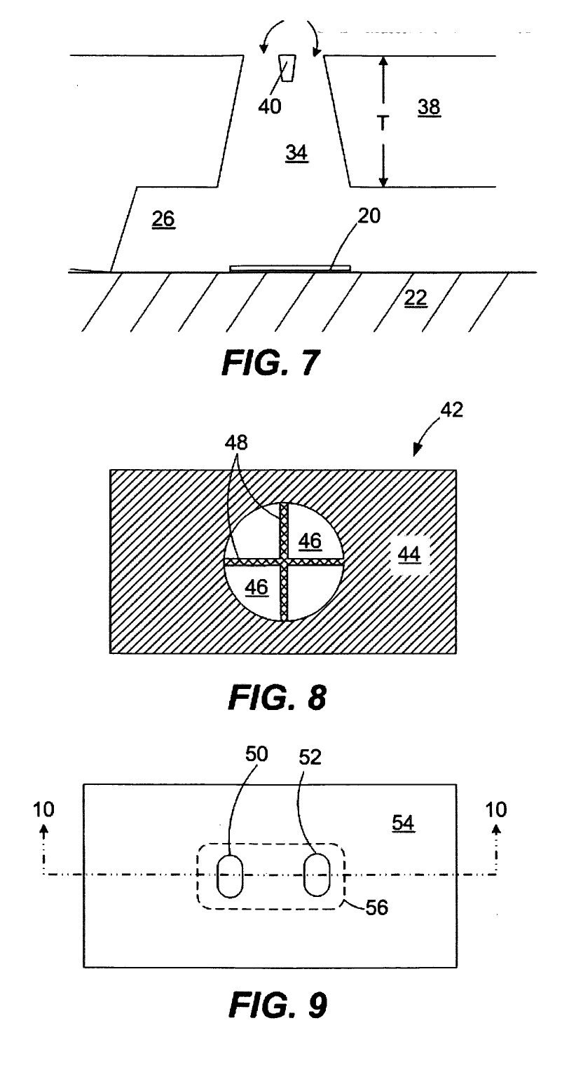

With reference to FIG. 7, a nozzle bore 34 and corresponding exit bores 36 may be ablated in a nozzle plate 38 from the fluid chamber 26 side of the nozzle plate 38. Such a process eliminates the need to flip the nozzle plate 38 over after forming nozzle bore 34 or exit bores 36. In this process, a laser beam is focused during ablation of the nozzle plate 38 to provide the partially ablated nozzle bore 34 and exit bore dividing member 40.

In an alternative process, a gray scale mask 42 (FIG. 8) may be used to form the exit bores 32 or 36 and exit bore dividing members 40 (FIG. 7) and 44 (FIG. 6). The gray scale mask 42 includes an opaque area 44, transparent areas 46, and a partially opaque area 48 corresponding to the dividing members 40 and 44 in nozzle plates 38 and 24, respectively. During ablation of the nozzle plate 24 or 38, the partially opaque area 48 causes ablation of the nozzle plate to proceed more slowly thereby forming dividing members 40 and 44. Ablation of the nozzle plate 24 or 38 for exit bores 32 or 36, respectively, would be terminated before ablation of the dividing members 40 or 44 is complete through the thickness T of the nozzle plate 38 or 24.

While nozzle plates 24 and 38 contain four exit bores 32 and 36, more or fewer exit bores may be provided in a nozzle plate to provide reduced droplet size. However, the overall volume of fluid ejected from exit bores 32 and 36 is substantially the same as the amount of fluid ejected from nozzle hole 16, FIGS. 1 and 2, e.g., from about one to about eight nanograms total. Also, the exit bores 32 and 36 may have any suitable shape including, but not limited to, semicircular, rectangular, triangular, or a combination of two or more of the foregoing shapes.

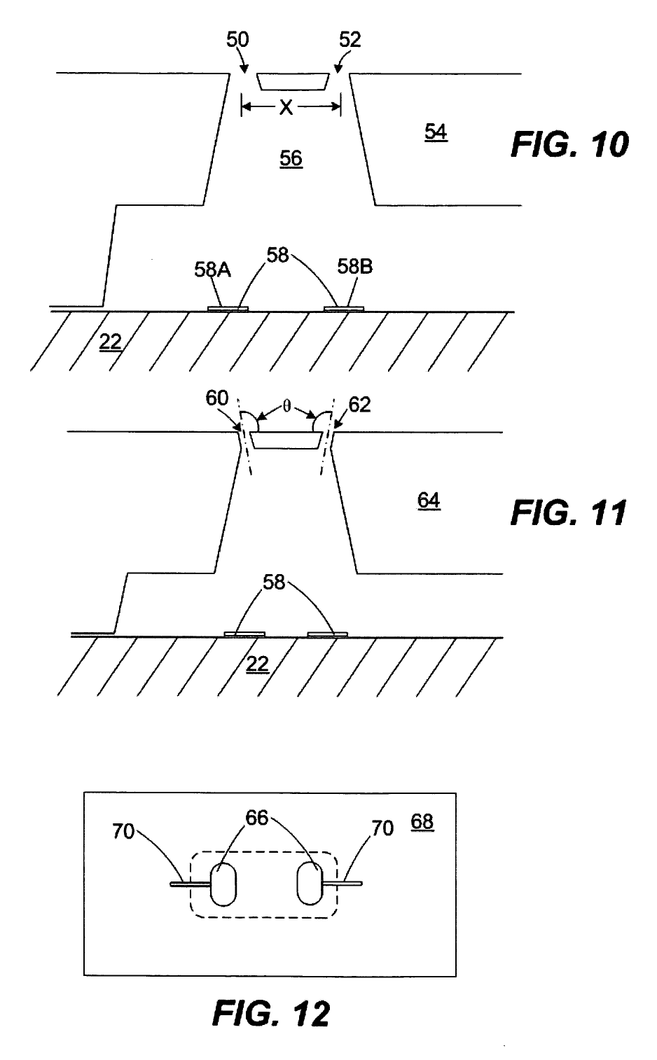

FIGS. 9-12 illustrate further embodiments of the disclosure. FIG. 9 is a plan view of substantially rectangular exit bores 50 and 52 having rounded corners formed in a nozzle plate 54 and corresponding to a substantially rectangular nozzle bore 56 having rounded corners. In this case the centers of exit bores 50 and 52 are separated from one another by a distance X ranging from about five to about 30 microns. The separation distance X should be sufficient to prevent droplet recombination upon exit of the droplets from the exit bores 50 and 52. As the droplets exit from the exit bores 50 and 52, the droplets tend to become spherical due to a surface tension of the ejected fluid. Accordingly, the distance X should be somewhat larger than a diameter of an individual spherical droplet ejected from the exit bores 50 and 52 when the droplet trajectories are substantially parallel to one another.

Also, with the separation distance X between the centers of exit bores 50 and 52, it may be desirable to provide a split fluid ejection actuator 58 having portions 58A and 58B that are connected to one another in series having substantially the same resistance as a single ejection actuator. The split fluid ejection actuator 58 wastes less energy since portions 58A and 58B need only heat fluid adjacent the portions 58A and 58B for flow through exit bores 50 and 52 respectively.

As mentioned above, a problem associated with ejecting multiple droplets of fluid from exit bores 32, 36, and 50 is that the droplets may tend to recombine into a single droplet a short distance from the nozzle plates 24, 38 and 54. Recombination of the individual droplets may occur due to decreased air pressure between the moving droplets or due to the surface tension of the fluid being ejected. If the separation distance X cannot be increased sufficiently to eliminate recombination of the droplets ejected, then exit bores 60 and 62 may be formed in a nozzle plate 64 at diverging angles θ as shown in FIG. 11. It will be appreciated that the exit bores 32 and 36 may also be formed with a diverging angle θ which may range from about 90° to about 150° to eliminate recombination of the droplets. Exit bores 60 and 62 may be formed with the diverging angles θ by use of the two-sided ablation process described above.

In the alternative, exit bores 66 in nozzle plate 68 may include notches or trenches 70 adjacent the exit bores 66 formed in the exit surface of the nozzle plate 68. The trenches 70 cause droplets ejected from the exit bores 66 to be misdirected toward the trenches 70. Accordingly, embodiments as described above provide multiple smaller droplets from a nozzle plate while maintaining substantially the same volume of fluid ejected per ejector activation sequence for each corresponding nozzle bore in the nozzle plate.

In the embodiments described above, the exit bore length L₁ may range from about 5 to about 100 percent of the overall nozzle bore length L₂. Nevertheless, a practical range may be from about 10 to about 80 percent of the nozzle bore length depending on the overall thickness T of the nozzle plate material. In other embodiments the exit bore length L₁ may range from about 10 to about 50 percent of the overall nozzle bore length L₂.

It is contemplated, and will be apparent to those skilled in the art from the preceding description and the accompanying drawings, that modifications and changes may be made in the embodiments of the disclosure. Accordingly, it is expressly intended that the foregoing description and the accompanying drawings are illustrative of preferred embodiments only, not limiting thereto, and that the true spirit and scope of the disclosed embodiments be determined by reference to the appended claims.

What is claimed is:

1. A nozzle plate structure having nozzle bores therein in flow communication with corresponding fluid chambers, the nozzle bores having an overall nozzle bore length dimension, each nozzle bore comprising two or more exit bores in fluid flow communication with each nozzle bore, each of the exit bores having a length dimension ranging from about 5 to about 100 percent of the overall nozzle bore length dimension.

2. The nozzle plate structure of claim 1, wherein the nozzle plate comprises three exit bores for each of the nozzle bores.

3. The nozzle plate structure of claim 1, wherein the nozzle plate comprises four exit bores for each of the nozzle bores.

4. The nozzle plate structure of claim 1, wherein the exit bores have diverging angles with respect to an exit surface of the nozzle plate.

5. The nozzle plate structure of claim 1, wherein the exit bores provide droplets having a droplet diameter and having substantially parallel trajectories and wherein a distance between centers of adjacent exit bores is greater than the droplet diameter.

6. The nozzle plate structure of claim 1, further comprising a notch in the nozzle plate for each of the exit bores.

7. The nozzle plate structure of claim 1, wherein the exit bores comprise rectangular exit bores.

8. The nozzle plate structure of claim 1, wherein the exit bores comprise circular exit bores.

9. The nozzle plate structure of claim 1, wherein the exit bores are configured for divergent fluid ejection therefrom.

10. The nozzle plate structure of claim 1, wherein the exit bores have a length dimension ranging from about 10 to about 60 percent of the overall nozzle bore length.

11. A micro-fluid ejection head comprising the nozzle plate structure of claim 1.

12. The micro-fluid ejection head of claim 11, wherein the exit bores provide multiple droplets having a total volume ranging from about one to about eight nanograms.

13. A method of making a nozzle plate for a micro-fluid ejection head, comprising:
partially laser ablating a single nozzle bore for each fluid chamber in a nozzle plate material; and
partially laser ablating multiple exit bores corresponding to each nozzle bore in the nozzle plate material, wherein the exit bores have a length dimension ranging from about 5 to about 100 percent of an overall nozzle bore length dimension.

14. The method of claim 13, wherein the nozzle bore and exit bores are laser ablated from a same side of the nozzle plate material.

15. The method of claim 14, wherein the nozzle bore and exit bores are laser ablated in the nozzle plate material using a gray scale mask.

16. The method of claim 13, wherein the nozzle bore and exit bores are laser ablated in the nozzle plate material from opposite sides of the nozzle plate material.

17. The method of claim 16, wherein a single laser having a split beam is used to laser ablate the nozzle bore and exit bores.

18. The method of claim 16, wherein two lasers are used to laser ablate the nozzle bore and exit bores.

19. The method of claim 16, wherein a single laser is used to laser ablate the nozzle bore and exit bores using a two-step laser ablation process.

20. The method of claim 13, further comprising laser ablating a notch on an exit surface of the nozzle plate material corresponding to each of the exit bores.

21. The method of claim 13, wherein the exit bores are laser ablated so as to provide divergent flow of fluid from the exit bores.

22. A method of reducing fluid droplet size without substantially reducing fluid droplet volume from a micro-fluid ejection head comprising:
partially laser ablating a single nozzle bore for each fluid chamber in a nozzle plate material;
partially laser ablating multiple exit bores corresponding to each nozzle bore in the nozzle plate material, wherein the exit bores have a length dimension ranging from about 5 to about 100 percent of an overall nozzle bore length dimension; and
attaching the nozzle plate material containing laser ablated nozzle bores and exit bores to a semiconductor substrate containing fluid ejection actuators, wherein fluid can be ejected from the exit bores of the nozzle plate material by activating the fluid ejection actuators to provide multiple droplets from the exit bores for each nozzle bore, wherein the multiple droplets have a total volume ranging from about one to about eight nanograms.

23. The method of claim 22, wherein the exit bores for each nozzle bore are provided by a dividing wall portion of the nozzle bores.

24. The method of claim 23, further comprising two or more fluid ejection actuators in series for each of the nozzle bores.

25. The method of claim 22, wherein the fluid ejected from the exit bores for each nozzle bore comprises discrete droplets of fluid.
